(19) United States
(12) Patent Application Publication
(10) Pub. No.: US 2026/0168303 A1
(43) Pub. Date: Jun. 18, 2026

(54) FLAP ASSEMBLY FOR AN OPENING IN A MOTOR VEHICLE'S OUTER CONTOUR

(71) Applicant: BOS GmbH & Co. KG, Ostfildern (DE)

(72) Inventors: Samuel ADAMS, Kalamazoo, MI (US); Mickey Alan HANNAN, Shelby Township, MI (US); William POMPILI, Shelby Township, MI (US); Satya Akhil Reddy BACHUGUDAM, Rochester Hills, MI (US)

(21) Appl. No.: 19/420,915

(22) Filed: Dec. 16, 2025

Related U.S. Application Data
(60) Provisional application No. 63/735,025, filed on Dec. 17, 2024.

(51) Int. Cl. E05F 1/10

(52) U.S. Cl. CPC E05F 1/10; E05Y 2201/716; E05Y 2201/722; E05Y 2900/53

(57) ABSTRACT

Flap assembly for an opening in a motor vehicle's contour, having a flap frame fixed to the vehicle in a ready-to-operate installed state. The flap frame defines an opening that is closable or openable by a flap that is positively guided on a guide system connected to the flap frame between a closed position and an open position. The flap is provided with rearward projecting support arms that are guided in a linearly mobile manner in linear guide tracks of the guide system. The linear guide tracks are arranged such that, on movement from the closed position, the flap is first tilted about a transverse axis and then pivoted upward in the vertical direction and into the opening.

### CROSS-REFERENCE TO RELATED APPLICATION

This claims priority from U.S. Provisional Application No. 63/735 025, filed Dec. 17, 2024, the disclosure of which is hereby incorporated by reference in its entirety.

### TECHNICAL FIELD

The invention relates to a flap assembly for an opening in a motor vehicle's outer contour, having a flap frame that is fixed to the vehicle in the ready-to-operate installed state, which flap frame defines an opening that is closable or openable by a flap that is positively guided on a guide system connected to the flap frame between a closed position and an open position.

### BACKGROUND AND SUMMARY

Such flap assemblies in the region of motor vehicles'outer contours are generally known. Such a flap assembly can be provided for closing and opening openings in a motor vehicle's interior or exterior contour. On the vehicle's exterior, an opening can be provided as access to a filling device for energy for propulsion drive of the motor vehicle. Alternatively, an opening for a sensor system or for fastening a trailer hitch can be provided in the region of a bumper. In the vehicle's interior, closable openings for stowing various items can be provided in a vehicle interior. Such openings on a vehicle's exterior or interior are often closable by way of a flap in order to protect the opening from fouling or, if arranged on the vehicle exterior, to prevent turbulence from airflow in the region of this opening.

The object of the invention is to provide a flap assembly of the above-stated type that ensures simple operability and good accessibility to the opening.

This object is achieved by the flap being provided with rearward projecting support arms that are guided in linearly mobile manner in linear guide tracks of the guide system, wherein the linear guide tracks are arranged such that, on movement from the closed position, the flap is first tilted about a transverse axis and then pivoted upward in the vertical direction and into the opening. The flap can also be denoted a door, hatch or lid. The flap assembly can correspondingly also be denoted door, hatch or lid assembly. According to the invention, the linear guide tracks are oriented at an inclination to one another such that the desired displacement of the flap between the closed position and the open position is obtained. Advantageously, at least one support arm is guided on one linear guide track and at least one other support arm is guided on at least one linear guide track inclined relative to the at least one first linear guide track. The terms rear side, transverse axis, and vertical direction refer to a coordinate system associated with the flap assembly. Therefore, if the flap is oriented horizontally in its closed position, the vertical direction is correspondingly a horizontal direction. The rear side is an inner side relative to the flap. The terms rear side, vertical direction, and transverse axis are therefore relative terms based on the orientation of the flap in its closed position. The same also applies to any further directional terms used in the present application text. The flap is preferably rectangular and has a total of four support arms that are in each case provided in pairs on opposite sides of the flap and project rearward and thus toward the opening. The support arms have pivot points by way of which the support arms are guided in the linear guide tracks. The pivot points are configured such that the respective support arm is mounted not only in linearly mobile manner in the corresponding linear guide track, but is additionally also mounted in rotationally mobile manner in the respective linear guide track. The proposed invention is suitable in principle for any kind of opening in a motor vehicle's exterior or interior contour. The flap assembly according to the invention is particularly advantageously provided for closing or opening an opening on a vehicle's exterior for a sensor system, for a power or fuel filling opening, or for a trailer hitch.

In one development of the invention, a drive device is associated with the flap, which drive device has a rack-and-pinion drive coupled to the flap, which rack-and-pinion drive is drivable in at least one movement direction by a drive motor. The rack-and-pinion drive advantageously has a spur gear and a rack that meshes with the spur gear, which rack is coupled to at least one support arm of the flap.

In a further development of the invention, the drive motor is configured as a mechanical spring motor. This is a particularly simple and functionally reliable variant. The spring motor is advantageously formed by a spiral spring.

In further development of the invention, the guide System has a securing track that secures the at least one support arm of the flap in the closed position against an opening movement brought about by a drive torque of the drive device. The securing track is preferably oriented at right angles to at least one linear guide track and opens into the corresponding linear guide track.

In further development of the invention, the flap is provided on its front side with a handle in order for it to be possible to manually displace the flap from the open position into the closed position against the drive torque of the drive device. The flap is operated via the drive device in the manner of a semiautomatic mechanism. Accordingly, while the flap is indeed automatically transferred from the closed position into the open position by way of the drive device, the opposite movement of the flap from the open position into the closed position is performed manually.

In a further development of the invention, a mechanical release unit is associated with the securing track, which release unit moves the support arm of the flap out of the securing track for transfer of the flap from the closed position into the open position. The securing track opens into a linear guide track that extends at an angle to the securing track. Once a corresponding pivot point of the support arm has been guided out of the securing track into the linear guide track, the pivot point of the support arm can be displaced along this linear guide track. If the guide system in each case has two mutually parallel linear guide tracks on opposite sides of the flap frame, two mutually parallel securing tracks are provided in each case in the opposite sides of the flap frame, in each of which is guided a pivot point in each case of a support arm. The mechanical release unit can nevertheless be associated with just one individual securing track since the flap is of dimensionally stable embodiment and therefore, when one support arm is displaced, the other support arm is at least largely reliably synchronously displaced in the other securing track.

In a further development of the invention, the mechanical release unit has a push-push system based on the ballpoint pen principle. The push-push system is here provided at its front end with a thrust member that can be of fork-like or claw-like configuration and comes into contact with the pivot point of the corresponding support arm in order to push the pivot point and thus the support arm out of the securing track.

In a further development of the invention, two support arms are in each case arranged on opposite edge regions of the flap, the drive device is positioned on one side of the flap frame, and a synchronization device is provided in order to transmit a drive torque synchronously to an opposite side of the flap frame. The synchronization device is of mechanical embodiment.

In further development of the invention, the synchronization device has a transmission shaft and a further rack-and-pinion drive that is associated with the opposite side of the flap frame. This reliably prevents the flap from twisting or tilting during an opening or closing movement.

Further advantages and features of the invention are revealed by the claims and by the following description of a preferred exemplary embodiment of the invention, which is explained with reference to the drawings.

### BRIEF DESCRIPTION OF THE DRAWINGS

FIG. 1 is a perspective representation of one embodiment of a flap assembly according to the invention with a flap in a closed position,

FIG. 2 shows the flap assembly according to FIG. 1 in an exploded representation viewed from a rear side,

FIG. 3 shows the flap assembly according to FIG. 1, but in an open position of the flap,

FIG. 4 is a front view of the flap assembly according to FIGS. 1 to 3,

FIG. 5 is a sectional representation of the flap assembly according to FIG. 4 along section line V-V in FIG. 4,

FIG. 6 is a front view of the flap assembly according to FIG. 4, but in a partially open intermediate position,

FIG. 7 is the flap assembly according to FIG. 6 in a sectional representation along section line VII-VII in FIG. 6,

FIG. 8 is a front view of the flap assembly according to FIGS. 4 and 6, but in the open position of the flap and

FIG. 9 is a sectional representation of the flap assembly according to FIG. 8 along section line IX-IX in FIG. 8.

### DETAILED DESCRIPTION

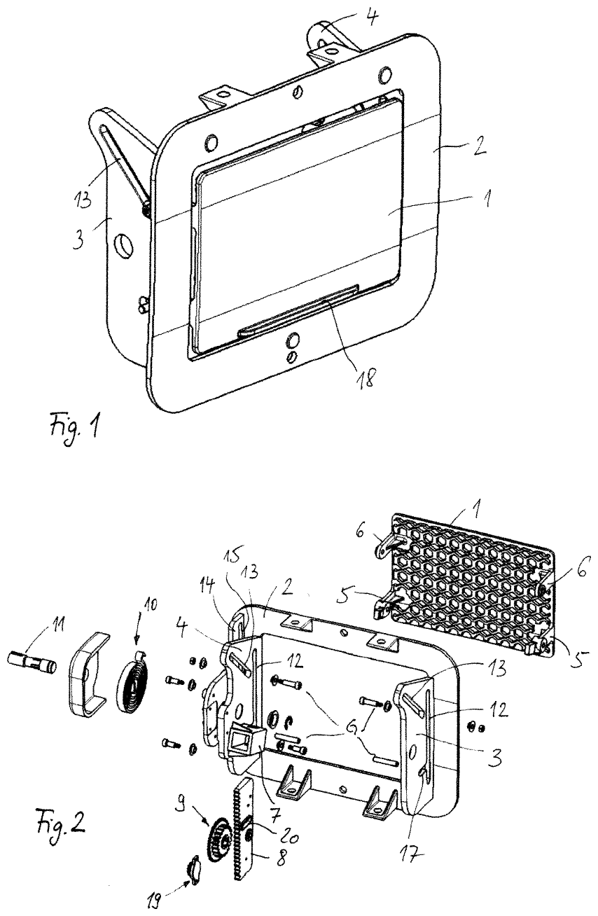

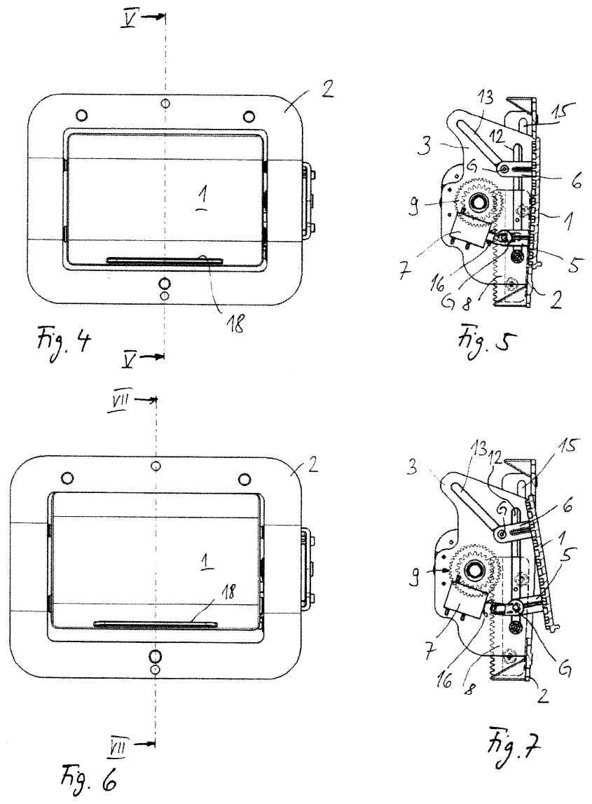

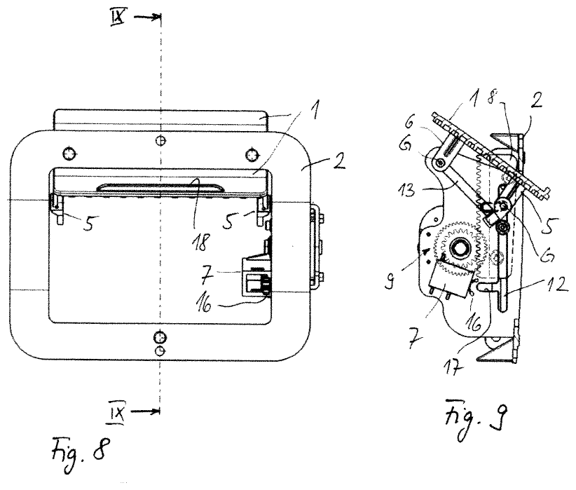

A flap assembly according to FIGS. 1 to 9 is provided for installation in an opening in a motor vehicle's exterior. The opening is positioned in an outer body contour, preferably in the region of an outer body skin or in the region of an outer contour of a front or rear bumper or in the region of another body panel on the vehicle's exterior.

The flap assembly has a substantially rectangular flap frame 2 that defines a rectangular opening. The flap frame 2 is made of plastics material. The flap frame 2 is provided with fastening portions molded in one piece that are not described in greater detail to enable installation of the flap frame 2 on structural parts on the vehicle. The flap frame 2 has a substantially flat surface on its front side. On its rear side, i.e., on an installation side of the flap frame 2, two rigid support walls 3 and 4 are molded in one piece on opposite side portions of the flap frame 2, which support walls 3 and 4 project orthogonally rearward to a plane of the flap frame 2. When the flap frame 2 is installed on the vehicle, the support walls 3 and 4 are oriented parallel to one another in the vertical direction of the vehicle. Linear guide tracks 12 and 13 configured as longitudinal slots are formed in the two support walls 3 and 4. Two linear guide tracks 12 adjacent to the flap frame 2 here extend parallel to one another in a straight line in the vertical direction of the vehicle, while two further linear guide tracks 13 are configured as slots that are inclined obliquely rearward and upward, are provided in upper portions of the two support walls 3 and 4, and are positioned at a short distance from the front linear guide tracks 12. A securing track 17 is further provided in each of the two support walls 3 and 4, which securing track 17 extends rearward orthogonally to the front linear guide track 12 at a distance below the respective linear guide track 13 and opens unobstructed into the respective linear guide track 12.

The support walls 3 and 4 together with the linear guide tracks 12 and 13 and the securing tracks 17 form a guide system within the meaning of the invention for the flap 1.

The largely flat flap 1 is made of plastics material and has honeycomb reinforcement on its rear side. The flap 1 has a rectangular outer contour and its dimensions are adapted to the rectangular opening of the flap frame 2 such that, in the closed position (FIG. 1), the flap 1 can completely close opening in the flap frame 2. On its rear side, the flap 1 has a total of four support arms 5, 6, wherein the support arms 5, 6 are positioned in pairs on opposite edge regions of the flap 1 and are firmly connected to, preferably molded in one piece on, the rear side of the flap 1.

All four support arms 5, 6 project rearward parallel to one another and orthogonally to the rear side of the flap 1. The two opposing, lower support arms 5 are guided in the front linear guide tracks 12 and in the securing tracks 17. The two upper support arms 6 are mounted in the rear linear guide tracks 13, which are inclined obliquely upward and rearward, of the two support walls 3, 4. To this end, all the support arms 5, 6 are provided with cylindrical pivot pins G that project into the linear guide tracks 12 and 13 or the securing tracks 17 and so enable longitudinal displacement of the support arms 5, 6 in the linear guide tracks 12, 13 and the securing tracks 17 and, at the same time, rotation of the support arms 5, 6 about pivot pins G that define corresponding axes of rotation.

On its front side, the flap 1 has at its lower transverse edge a handle 18 that projects forward in the manner of a fin and enables the flap 1 to be gripped or operated manually.

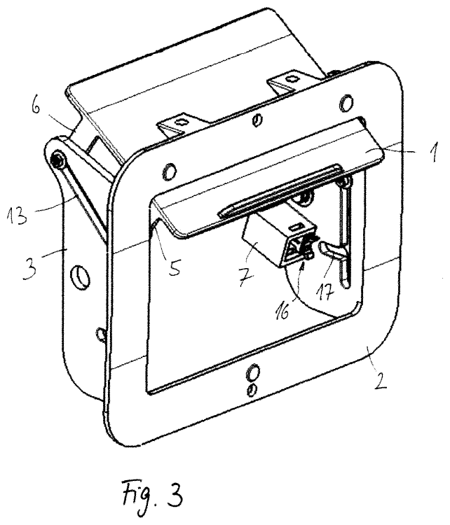

A drive device that has a drive motor in the form of a spiral spring motor 10 is provided to displace the flap 1 between the closed position (FIG. 1) and the open position (FIG. 3). The spring motor 10 is positioned on a housing wall 14 that projects rearward on the rear side from the lateral edge portion of the flap frame 2 parallel to the support wall 4 and is molded in one piece on the flap frame 2 in a similar manner to the support wall 4. The spring motor 10 is positioned on the outside of the housing wall 14, wherein the spring motor 10 is held on a drive shaft 11 that is rotatably mounted in the housing wall 14. A housing lid (not described in any further detail) is associated with the housing wall 14 on the outside, which housing lid on the one hand mounts an external end region of the drive shaft 11 and on the other hand houses the spring motor 10.

A receiving space, in which a rack-and-pinion drive with a rack 8 and a pinion 9 is arranged, is formed between the housing wall 14 and the support wall 4. The pinion 9 has two different spur gear rings, wherein a smaller spur gear ring meshes with toothing of the rack 8. An outer spur gear ring meshes with a pinion of a damper 19 configured as a silicone brake. The damper 19 is fastened to the housing wall 14 or to the support wall 4. The housing wall 14 has at least one linear guide 15 in which the rack 8 is guided in linearly mobile manner in the vertical direction. Rotation of the pinion 9 located on the drive shaft 11 necessarily brings about, depending on the direction of rotation of the pinion 9, linear displacement of the rack 8 upward or downward in the vertical direction. A pivot pin G of the lower support arm 5 is coupled to the rack 8, which lower support arm 5 is displaceably guided in the linear guide track of the support wall 4. The corresponding pivot pin G is displaceably guided in a longitudinal groove 20 (FIG. 2) of the rack 8 that is oriented transversely of the linear displacement direction of the rack 8.

In the closed position of the flap 1, this longitudinal groove 20 is located at the level of the securing track 17, i.e., the rack 8 is displaced so far downward that the longitudinal groove 20 and the securing track 17 are aligned with one another.

As is apparent from FIG. 4, the pivot pins G of the lower support arms 5 of the flap 1 dip into the securing tracks 17 when the flap 1 is in the closed position. In this closed position, the corresponding pivot pin G is additionally positioned in the longitudinal groove 20 of the rack 8. The upper support arms 6 of the flap 1 are located at a lower, front edge region of the upper, obliquely extending linear guide tracks 13 of the support walls 3 and 4. The lower support arms 5 with their pivot pins G are thus captured in the securing tracks 17. A mechanical release unit, in the present case in the form of a push-push system 16, is mounted in limited linearly mobile manner in a chamber 7 that is molded on the inside of the support wall 4 in order to move these pivot pins G and thus the lower support arms 5 forward out of the securing tracks 17. The pivot pins G of the lower support arms 5 of the flap 1 do not abut against a rear end of the securing tracks 17 but are instead positioned at a short distance in front of this end region in this closed position. If pressure is now manually exerted from the outside on the handle 18 of the flap 1, the adjacent pivot pin G slides rearward, so actuating the push-push system 16. As a result, the push-push system 16 pushes the corresponding pivot pin G, against which it is resting, forward. This releases the lower support arms 5 with their corresponding pivot pins G from the securing tracks 17, so also unblocking the pretensioned spring motor 10. The spring motor 10 can now set the pinion 9 in rotation, so displacing the rack 8 upward from its lower end position in the corresponding linear guide 15. As a result, the lower support arms 5 are likewise necessarily displaced upward in the front linear guide track 12. This movement is additionally transmitted to the upper support arms 6 that slide by way of their pivot points G rearward in the upper linear guide tracks 13 that extend obliquely rearward and upward. The spring motor 10 thus necessarily moves the flap 1 into its open position in which the pivot pins G of the support arms 6 abut against the end of the upper linear guide tracks 13.

In order to return the flap 1 from this open position back into the closed position, an operator grips the handle 18 of the flap 1 with the fingers of their hand and presses it downward. As a result, the pivot pins G of the support arms 5 and 6 necessarily perform a correspondingly revered displacement movement, so retensioning the spring motor 10. Once the pivot pins G of the lower support arms 5 in the linear guide tracks 12 have again reached the level of the securing tracks 17, the pivot pins G necessarily slide into these securing tracks 17. In so doing, the pivot pin G associated with the push-push system 16 pushes the push-push system 16 back into its tensioned initial position. In this position, the flap 1 is now held in a self-locking position since the gearwheel 9 and the spring motor 10 apply a permanent upward force in the vertical direction to the rack 8. The flap 1 is accordingly held securely and in form-locked manner in its closed position.

1. A flap assembly for an opening in a motor vehicle's contour, the flap assembly comprising a flap, a flap frame fixed to the vehicle in a ready-to-operate installed state, a guide system connected to the flap frame and having linear guide tracks, the flap frame defining an opening closable or openable by the flap, the flap being positively guided on the guide system between a closed position and an open position, the flap including rearward projecting support arms guided in a linearly mobile manner in the linear guide tracks of the guide system, the linear guide tracks being arranged such that, on movement from the closed position, the flap is first tilted about a transverse axis and is then pivoted upward in the vertical direction and into the opening of the flap frame.

2. The flap assembly as claimed in claim 1, further comprising a drive device associated with the flap, the drive device having a motor and a rack-and-pinion drive coupled to the flap, the rack-and-pinion drive being drivable in at least one movement direction by the drive motor.

3. The flap assembly as claimed in claim 2, wherein the drive motor is configured as a mechanical spring motor.

4. The flap assembly as claimed in claim 2, wherein the guide system has a securing track securing at least one of the support arms of the flap in the closed position against an opening movement brought about by a drive torque of the drive device.

5. The flap assembly as claimed in claim 4, wherein the flap includes on a front side thereof a handle for manual displacement of the flap from the open position into the closed position against the drive torque of the drive device.

6. The flap assembly as claimed in claim 4, further including a mechanical release unit associated with the securing track, the release unit moving the at least one support arm of the flap out of the securing track to transfer the flap from the closed position into the open position.

7. The flap assembly as claimed in claim 6, wherein the mechanical release unit includes a push-push system.

8. The flap assembly as claimed in claim 1, further including a drive device associated with the flap and a synchronization device, the support arms are arranged on respective opposite edge regions of the flap, the drive device is positioned on one side of the flap frame, and the synchronization device transmits a drive torque synchronously to an opposite side of the flap frame.

9. The flap assembly as claimed in Claim 8, wherein the synchronization device has a transmission shaft and a further rack-and-pinion drive associated with the opposite side of the flap.
